(19) United States
(12) Patent Application Publication
(10) Pub. No.: US 2021/0195515 A1
(43) Pub. Date: Jun. 24, 2021

(54) Guest Tracking and Management Systems and Methods

(71) Applicant: TracTrakr, LLC, Salt Lake City, UT (US)

(72) Inventors: Pierre-Jean Beney, Brian Head, UT (US); Burke Wilkerson, Cedar City, UT (US)

(21) Appl. No.: 17/129,817

(22) Filed: Dec. 21, 2020

Related U.S. Application Data
(60) Provisional application No. 62/950,912, filed on Dec. 19, 2019.

(51) Int. Cl. H04W 52/02; H04W 84/18

(52) U.S. Cl. CPC H04W 52/0203; H04W 52/0216; H04W 84/18; H04W 52/0251; H04W 52/0219

(57) ABSTRACT

A guest tracking and management system includes at least one guest beacon device being associated with a guest within a venue, at least one tracker device being associated with a venue representative, at least one beacon station being associated with a location within the venue, and at least one tracker station being associated with a location within the venue. The system also includes a centralized guest management system. The guest beacon device communicates with the tracker device and the beacon station using a short-range communication protocol, the tracker device and the beacon station communicate with the tracker station using a short-range communication protocol, and the beacon station and tracker station communicate with the centralized guest management system using a low-power wide-area network.

### RELATED APPLICATIONS

This application claims the benefit of U.S. Provisional Patent Application No. 62/950,912 entitled “GUEST TRACKING AND MANAGEMENT SYSTEMS AND METHODS” and filed on Dec. 19, 2019, which is incorporated herein by reference.

### FIELD OF TECHNOLOGY

The present disclosure relates generally to systems and methods for tracking and managing guests within a venue. More specifically, but not exclusively, the present disclosure relates to systems and methods for tracking and managing guests within a venue using relatively low power short range communication devices.

### BACKGROUND

There are various reasons for wanting to track guests within a venue. In some cases, the guests may be children or others whose location within a venue is useful or even highly sought after information for parents or guardians. In some cases, there may be a need to track the path of guests throughout a venue over time, such as for contact tracing for illness, for progress toward a goal, or for advertising or consumer behavior information. In yet other cases, the location of guests within a venue may be desirable for those working within the venue who oversee the guests, including the frequency and location of interactions between the guests and the workers. In each of these situations, it may be desirable to have a system that precisely tracks the location of guests, including using relatively low power, short range communication devices.

A number of devices exists that attempt to solve this problem, including Bluetooth and Bluetooth Low Energy devices that transmit to receivers, including smart phones, for tracking the general location of devices or people. However, there remains a need for more precise and more efficient means for tracking and managing the location and movements of guests within a venue.

### BRIEF DESCRIPTION OF THE DRAWINGS

The inventive body of work will be readily understood by referring to the following detailed description in conjunction with the accompanying drawings, in which:

FIG. 1 illustrates an example of a guest tracking and management architecture content consistent with certain embodiments of the present disclosure.

FIG. 2 illustrates an example of a system that may be used to implement certain embodiments of the systems and methods of the present disclosure.

FIG. 3 illustrates an example of a guest device or beacon device according to certain embodiments of the present disclosure.

FIG. 4 illustrates an example of a tracker device or receiver according to certain embodiments of the present disclosure

FIG. 5 illustrates an example of a beacon station or tracker station according to certain embodiments of the present disclosure.

FIG. 6 illustrates an example of tracking of athlete performance according to certain embodiments of the present disclosure.

### DETAILED DESCRIPTION

The present disclosure relates generally to systems and methods for tracking and managing guests within a venue. More specifically, but not exclusively, the present disclosure relates to systems and methods for tracking and managing guests within a venue using relatively low power short range communication devices.

In certain venues, including venues having relatively large open areas such as, for example and without limitation, hotels, outdoor resorts, schools, winter resorts and associated snow sport schools and/or complexes, summer camps, amusement parks, and/or the like, it may be desirable to track the location of guests within the venue. It may be further desirable to track associations between venue employees and/or representatives (e.g., snow sports school instructors) and guests to better manage programs offered by the venue and and/or improve the guest experience.

Conventional guest tracking and/or management methods may rely primarily on centralized databases and may not readily allow for the dynamic updating of guest associations throughout the course of a day. For example, in connection with an instructional lesson performed at a venue, a guest and an instructor may be linked at the beginning of the day in a centralized database (e.g., by manually entering the association record and/or scanning barcode tickets and/or RFID tags associated with the guest and the instructor by a centralized system). It may be difficult, however, to change association links between a guest and an instructor midday without returning to the centralized system. Moreover, while guests and/or instructors may carry cellular telephones and/or other GPS-enabled mobile devices that may be used to track their location, such devices are relatively large, heavy, have intermittent connectivity, and/or may require relatively frequent recharging.

Consistent with certain embodiments of the disclosed systems and methods, guest tracking and management techniques are described that may facilitate more dynamic creation and updating of guest association link records, including records associating and/or otherwise linking guests with venue employees and/or representatives (e.g., instructors). Various embodiments disclosed herein may employ modular devices that may be used to establish, update, and/or otherwise track associations between guests and venue employees and/or representatives, locate guests within a venue, and/or the like.

In various embodiments, guest devices, which may be referred to herein in certain instances generally as guest beacon devices, may be associated with guests. Guest beacon devices may communicate with tracker devices, which may be mobile in nature and be carried by venue employees and/or representatives, and/or fixed-location beacon stations to, among other things, track the location of the guest beacon devices and/or establish and/or update associative links between guest beacon devices (and by extension associated guests) and/or tracker devices (and by extension associated venue employees and/or representatives).

Guest beacon devices may communicate with tracker devices using relatively short-range communication protocols such as, for example and without limitation, Bluetooth Low Energy (“BLE”), ultra-wideband (“UWB”), RFID, and/or the like. Tracker devices may communicate with a guest management system via one or more tracker stations distributed throughout a venue establishing a private dedicated open-area wireless communication network using a suitable low-power wide-area network (“LPWAN”) communication technology such as, for example and without limitation, LoRa (e.g., using sub-gigahertz RF bands like 915 MHz). Tracker devices may be used to manage and/or otherwise link with one or more guest beacon devices, and may communicate such associative linkage information and/or location information to a guest management system, allowing for improved management and/or tracking of guests within a venue.

A description of the systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, wherein like parts may in some instances be designated by like numbers or descriptions. The components of the disclosed embodiments, as generally described and/or illustrated in the figures herein, could be arranged and designed in a wide variety of different configurations. Thus, the following description of the embodiments of the systems and methods of the disclosure is not intended to limit the scope of the disclosure, but is merely representative of possible embodiments of the disclosure. In addition, the steps of any method disclosed herein do not necessarily need to be executed in any specific order, or even sequentially, nor need the steps be executed only once, unless otherwise specified.

Embodiments of the disclosed systems and methods provide techniques for tracking and/or otherwise managing guests within a venue. Further embodiments disclosed herein may allow for the dynamic creation and/or updating of guest associative link records including records associating and/or otherwise linking guests with venue employees and/or representatives (e.g., instructors). Various embodiments disclosed herein may employ modular devices including guest beacon devices and/or tracker devices, fixed-location beacon scanning devices that may be referred to in certain instances herein as beacon stations, and/or tracker stations establishing a private dedicated open-area wireless communication network within a venue to facilitate communication between tracker devices, beacon stations, and/or a guest management system.

Various examples detailed herein may describe embodiments of the disclosed systems and methods in connection with a guest tracking and management system implemented by a snow sports school of a winter sports resort. In certain examples provided herein, guest beacon devices may be associated with guests and/or students enrolled in snow sports school classes at the resort, and tracker devices may be associated with snow sports instructors and/or other representatives of the winter sports resort. It will be appreciated, however, the disclosed embodiments may be used in a variety of other suitable applications and/or contexts, and that any examples provided herein are provided for the purposes of explaining various aspects of the disclosed embodiments and should not be viewed as limiting.

In connection with a winter snow sports school, it may be desirable to know and track which instructors, supervisors, and/or other resort representatives (that may be referred to generally in certain instances herein as “instructors”) have custody of and/or responsibility for which guests, students, and/or trainees visiting the resort (that may be referred to generally in certain instances herein as “guests”). Information recording this custody and/or responsibility may be established at the beginning of the day, lesson, session, visit, and/or the like, but may also change throughout the day and/or otherwise require updating.

Various embodiments disclosed herein provide for the dynamic creation and/or updating of records associating and/or otherwise linking guests with instructors. In this manner, guests may switch instructors and/or associated classes midday, and guest records may be updated dynamically and with relative ease to associate the guest with a new class and/or instructor using various aspects of the disclosed embodiments.

Further embodiments of the disclosed systems and methods may be used to track the location of guests and/or instructions within a venue, identify certain anonymous conditions such as guests that may have strayed away from assigned instructors, and/or allow and/or otherwise authenticate physical access to certain parts of a venue. By using a private open-area wireless communication network using a suitable low-power wide-area network technology, various embodiments of the disclosed systems and methods may allow for such functionality even when public network access within the venue may be limited.

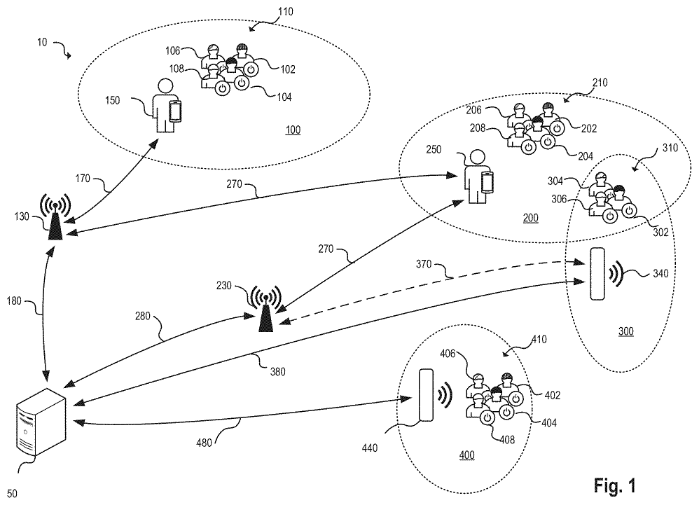

FIG. 1 illustrates an example of a guest tracking and management architecture content consistent with certain embodiments of the present disclosure. As described in more detail below, the guest tracking system 10 may include one or more guest beacon devices 102, 104, 106, 108, 202, 204, 206, 208, 302, 304, 306, 402, 404, 406, 408, tracker devices 150, 250, beacon stations 340, 440, tracker stations 130, 230, and/or a centralized guest tracking and management system 50.

System 10 may include groups of guests, such as guest group 110 including guest beacon devices 102, 104, 106, 108, guest group 210 including guest beacon devices 202, 204, 206, 208, guest group 310 including guest beacon devices 302, 304, 306, and guest group 410 including guest beacon devices 402, 404, 406 and 408. For example, a group of gusts assigned guest beacon devices 102, 104, 106 and 108 may be designated as a group in the central system 50. Moreover, guest groups 110, 210, 310, 410 may be assigned to a venue representative by assignment to a tracker device 150, 250 assigned to a venue representative.

System 10 may also include a plurality of beacon stations 340, 440, which may communicate with guest beacon devices as discussed in more detail herein. System 10 may also include a plurality of tracker stations 130, 230, which may communicate with tracker devices 150, 250 as discussed herein. For example, tracker devices 150, 250 and/or beacon stations 340, 440 may communicate with tracker stations 130, 230 using a short range communication protocol 170, 270, 370. Moreover, tracker stations 130, 230 and beacon stations 340, 440 may communicate with the central system 50 using low-power wide-area network 180, 280, 380, 480, as discussed herein in more detail.

Guest Beacon Devices

In various embodiments, a guest beacon device may comprise a relatively small and/or lightweight portable communication device. Guests within a program offered by a venue (e.g., a snow sports school program) may be given and/or otherwise loaned a guest beacon device during their time in the program. The guest beacon device may be configured to consume relatively little energy and, therefore, may require relatively infrequent recharging. In further embodiments (e.g., embodiments employing guest beacon devices that use RFID technology), guest beacon devices may not require recharging. In some embodiments, a guest beacon device may be configured as a wearable device.

The guest beacon device may store certain identification information. In certain embodiments, the identification information may comprise information uniquely identifying the beacon guest device (e.g., beacon ID and/or serial numbers and/or the like). The guest beacon device may, alternatively and/or additionally store information identifying an associated guest (e.g., a guest ID number, name, contact information, photo, class and/or session information, etc.).

In some embodiments, the guest beacon device may further store associative link information, linking the guest beacon device and/or associated user with a tracker device and/or associated instructor. Guest information and/or associated link information may be initially stored on the guest beacon device during a guest beacon device initialization and/or configuration process (e.g., a process performed by a guest management system and/or the like).

In certain embodiments, a guest beacon device may be configured to communicate with one or more tracker devices and/or beacon stations. In some embodiments, guest beacon devices may communicate using relatively short-range and/or low energy communication protocols such as, for example and without limitation, BLE, UWB, RFID, and/or the like. In some embodiments, guest beacon devices may communicate using shorter-range communication technologies extending up to approximately 100 feet, although other ranges are also contemplated.

In some embodiments, a guest beacon device may include one or more interfaces and/or buttons allowing for configuration of the guest beacon device and/or its functions. For example, a guest beacon device may comprise one or more buttons to allow the beacon's transmission power and/or transmission frequency to be changed and/or otherwise customized. Various guest beacon device interfaces may further be used to configure information transmitted to and/or from the guest beacon device for various operations involving the guest beacon device (e.g., check-in, access rights, payment, etc.).

Guest beacon devices may further include interfaces that may be used to display certain information stored by the guest beacon device including, for example and without limitation, guest information and/or associative link information stored by the guest beacon device. For example, a guest beacon device may comprise a relatively low-power screen such as, for example and without limitation, an e-paper display, which may allow for the display of guest information including guest names, photographs, medical information (e.g., guest allergy information) and/or associative link information including an assigned instructor name and/or associated classes and/or sessions.

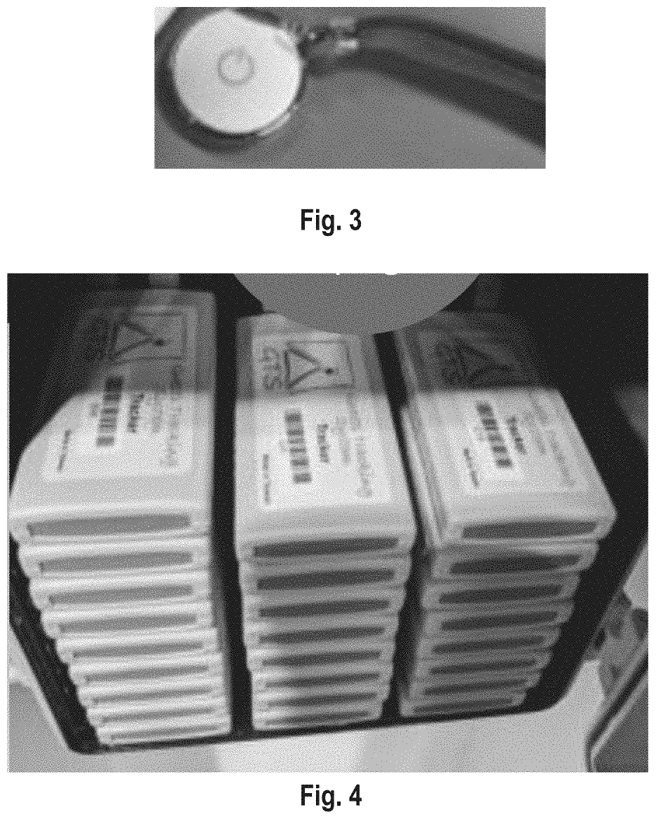

In certain embodiments, guest beacon devices may further comprise accelerometers and/or other associated subsystems. For example, an accelerometer may be used to determine “single taps” and/or “double taps” and/or other physical gestures made by a user using a guest beacon device to initialize the guest beacon device, update the device with new information, and/or interact with other device functionalities. In further embodiments, an accelerometer may also be used to detect certain movement (e.g., abrupt falls) and/or lack of movement for an extended period of time, and such information may be communicated from the guest beacon device to tracker devices, beacon stations, and/or the guest management system (e.g., by way of a tracker device and/or a beacon station) to alert instructors and/or other responsible parties of the occurrence of certain conditions that may require their attention (e.g., an injured guest). An example of a guest beacon device is shown in FIG. 3.

Tracker Devices

Tracker devices may comprise portable communication devices that, relative to, guest beacon devices, have additional communication capabilities. Instructors and/or other responsible parties associated with a program may each carry a tracker device and/or use a tracker device in various contexts. Tracker devices may, in certain instances, be further issued to one or more guests so as to extend a scanning area within a venue.

Tracker devices may be configured to scan for and/or otherwise communicate with proximately located guest beacon devices using relatively short-range and/or low energy communication protocols such as, for example and without limitation, BLE, UWB, RFID, and/or the like. In certain embodiments, tracker devices may be configured to read information from a proximately located guest beacon device. For example, tracker devices may be configured to read guest information (e.g., guest name, photographs, medical information, ability level), guest beacon device information (e.g., beacon IDs and/or serial numbers), and/or associative link information (e.g., assigned instructor name, assigned class and/or session, etc.) from a proximately located guest beacon device

In various embodiments, tracker devices may continuously scan for proximately located guest beacon devices. In further embodiments, tracker devices may periodically scan for proximately located guest beacon devices. Periodically scanning for proximately located guest beacon devices may, in some instances, help to conserve power consumed by the tracker device.

Tracker devices may further be configured to provision information to proximately located guest beacon devices. Consistent with various aspects of the disclosed embodiments, tracker devices may be used to generate and/or update guest information and/or associated link information stored by a guest beacon device. For example, tracker devices may be used to, among other things, initialize a guest beacon device with guest and/or associative link information and/or update link information (e.g., guest instructor name, class, session information, and/or the like) stored by the device. In this manner, guests may switch instructors and/or associated classes midday, and guest records stored by guest beacon devices may be updated dynamically and with relative ease to associate the guest with a new class and/or instructor.

Tracker devices may comprise communication hardware and functionality allowing for communication with an open-area wireless communication network. In some embodiments, the communication network may comprise a private and/or otherwise dedicated communication network associated with a venue. The communication network may utilize any suitable LPWAN communication technology such as, for example and without limitation, LoRa. In certain embodiments, tracker devices may connect to the open-area wireless communication network (and/or an associated guest management system) via one or more tracker stations, described in more detail below. In further embodiments, tracker devices may communicate with other tracker devices and/or beacon stations in a peer-to-peer manner. In some circumstances, this may allow for a tracker device that does not have available direct network connectivity to communicate with another tracker device and/or beacon station that does have direct network connectivity to access the open-area wireless communication network.

In some embodiments, tracker devices may comprise one or more location sensor systems such as, for example and/or without limitation, GPS, Glonass, Beidou, and/or Galileo-based sensor systems, and/or any combination thereof. In some embodiments, such location sensor systems may provide a tracker device with relatively precise location information of the device and/or synchronization timing clock information.

Tracker devices may further comprise one or more accelerometers and/or other associated subsystems. For example, an accelerometer may be used to determine “single taps” and/or “double taps” and/or other physical gesture-based controls made by a user of the tracker device in connection with a guest beacon device to initialize the guest beacon device, update device with new information, and/or interface with other tracker device functionality. In further embodiments, an accelerometer may also be used to detect certain movement (e.g., abrupt falls) and/or lack of movement of a tracker device for an extended period of time, and such information may be communicated from the tracker device to other tracker devices and/or the guest management system to alert instructors and/or other responsible parties of the occurrence of certain conditions that may require their attention (e.g., an injured ski instructor, a tracker device dropped from a ski lift, and/or the like).

A tracker device may include one or more interfaces, indicators, and/or buttons allowing for configuration of the tracker device and/or its functions and/or for interaction with the device. For example, a tracker device may comprise one or more buttons to allow for configuration of frequency at which the tracker device scans for proximate guest beacon devices, various network communication settings, various information associated with the tracker device (e.g., tracker device ID information, associated instructor information, class and/or session information, and/or the like).

In some embodiments, the tracker device may further comprise one or more indicators and/or interfaces (e.g., audio and/or visual indicators) indicating network connection status, communication status with guest beacon devices, tracker stations, and/or the guest management system, certain device modes (e.g., beacon initialization/updating/linking modes), message receipt status, and/or the like.

In certain embodiments, a tracker device may be configured to operate as a communication device to receive messages, and may include associated interfaces to enable this functionality. For example, a tracker device may be used to send and/or receive small messages (e.g., text, audio, and/or visual messages) broadcast from another tracker device and/or from the guest management system (that may be broadcast to multiple deployed tracker devices). Such messages may include, for example and without limitation, guest allergies, medications, weather updates, area openings/closings and/or the like. Tracker devices may further be configured to send messages to other tracker devices and/or the guest management system such as, for example and without limitation, acknowledgements, yes and/or no answers to received queries, and/or the like.

One or more interfaces of the tracker device may further be configured to display guest information, beacon information, and/or associated link information read from scanned guest beacon devices, stored by the tracker device, and/or accessed by the tracker device from the guest management system. For example, an instructor may view guest information via an interface of a tracker device including, for example and without limitation, guest names, photographs, medical information (e.g., guest allergy information) and/or associative link information including an assigned instructor name and/or associated classes and/or sessions of a scanned guest beacon device.

The tracker device may record in internal memory information read from scanned guest beacon devices, information associated with the tracker device and link association records associated with the tracker device linking the tracker device (and/or an associated instructor) with one or more guest beacon devices (and/or associated guests), location information associated with the tracker device, and/or information received from the guest management system. In further embodiments, the tracker device may store timestamp information relating to certain interactions between an instructor and the tracker device and/or interactions with other systems and/or devices (e.g., tracker stations, other tracker devices, beacon stations, and/or guest beacon devices), accelerometer information, and/or timestamp information.

Tracker devices may be used to, among other things, track the location of guests using guest beacon devices associated with the guests. For example, in the illustrated architecture shown in FIG. 1, tracker device 150 may perform a scan and identify a plurality of proximately located guest beacon devices 102, 104, 106, 108 forming guest group 110. Information received from the guest beacon devices 102, 104, 106, 108 (e.g., guest and/or beacon ID information) may be associated with a location of the tracker device 150 determined using an associated location sensor and communicated to the guest managing system 50 (and/or other tracker devices 250). In this manner, a user interacting with the guest management system may determine that the guests associated with the guest beacon devices 102, 104, 106, 108 of beacon device group 1 are located nearby the indicated location of tracker device 1.

In some embodiments, an approximate location of identified guest beacon devices scanned by a tracker device may be determined based on location information determined by a location sensor system of the tracker device. That is, the location of a scanned guest beacon device may be associated with a determined location of the tracker device. In further embodiments, the location of identified guest beacon devices may be determined based on interaction between multiple tracker devices and/or beacon stations. For example, a location of a guest beacon device may be triangulated based on information received from the guest beacon device from multiple tracker devices and/or beacon stations (e.g., based on relative signal strength and/or the like).

In certain embodiments, a tracker device may function as like a guest beacon device, allowing the tracker device to be scanned and/or otherwise be detected by a beacon station, as described in more detail below. For example, when a GPS and/or other location-based signal is not available (e.g., in an indoor venue and/or in a canyon), the location of the tracker device may be determined based on being scanned by a beacon station associated with a known location. An example of a tracker device is shown in FIG. 4.

Beacon Stations

Beacon stations may, in some embodiments, comprise devices having a fixed and/or otherwise known location that may be configured to scan for and/or otherwise communicate with proximately located guest beacon devices and/or tracker devices using relatively short-range and/or low energy communication protocols such as, for example and without limitation, BLE, UWB, RFID, and/or the like.

Beacon stations may operate similar to tracker devices (albeit with a fixed and/or otherwise known location) and may include some and/or all of the features, elements, and/or functionality of tracker devices described above. In some embodiments, beacon stations may be distributed throughout a venue and/or located in certain strategic locations. For example, in connection with a winter ski resort, beacon stations may be located at the bottom and/or top of chairlifts, gondolas, and/or trams, lodges, backcountry gates, and/or other gathering places and/or thoroughfares within the resort venue. As described in more detail below, in some embodiments, beacon stations may also be associated with access control gates.

Beacon stations may scan for and/or read information from proximately located guest beacon devices and/or tracker devices. In various embodiments, beacon stations may continuously scan for proximately located guest beacon devices and/or tracker devices. In further embodiments, beacon stations may periodically scan for proximately located guest beacon devices and/or tracker devices.

In some embodiments, the size of the scanner area of a beacon station may be configurable. For example, a beacon station can be configured as a larger area proximity detector using a relatively large scanning area. In further implementations, certain beacon stations may be configured to scan for guest beacon devices and/or tracker devices located relatively close to a scanner associated with a beacon station (e.g., a few inches). For example, in applications where a beacon station is used to check-in to certain locations, used to facilitate access rights management, and/or for payment, as described in more detail below, beacon stations may employ relatively close scanning areas. In various embodiments, the scanning area of a beacon station may be adjusted by changing a relative signal strength indicator (“RSSI”) used to identify proximately located devices (e.g., a BLE and/or RFID RSSI and/or a combination thereof).

In certain embodiments, beacon stations may be configured to read information from proximately located guest beacon devices and/or tracker devices. For example, beacon stations may be configured to read guest information (e.g., guest name, photographs, medical information, ability level), guest beacon device information (e.g., beacon IDs and/or serial numbers), and/or associative link information (e.g., assigned instructor name, assigned class and/or session, etc.) from a proximately located guest beacon device and/or tracker devices. In some embodiments, beacon stations may be configured to relay information obtained from tracker devices to the guest management system.

Beacon stations may comprise communication hardware and functionality allowing for communication with an open-area wireless communication network that may comprise a private and/or otherwise dedicated communication network associated with a venue. As described above, the communication network may utilize any suitable LPWAN communication technology such as, for example and without limitation, LoRa. In certain embodiments, beacon stations may connect to the open-area wireless communication network (and/or an associated guest management system) via one or more tracker stations, described in more detail below. In further embodiments, beacon stations may communicate with other tracker devices and/or beacon stations in a peer-to-peer manner. In some circumstances, this may allow for a beacon station that does not have available direct network connectivity to communicate with another beacon station that does have direct network connectivity to access the open-area wireless communication network.

In further embodiments, beacon stations and/or a subset thereof may be configured to communicate with the guest management system using a different wireless network than the network provided by the tracker stations and/or used by tracker devices. In yet further embodiments, beacon stations and/or a subset thereof may be configured to communicate directly with the guest management system. For example, in certain embodiments, beacon stations may be configured to communicate directly with the guest management system using one or more wired communication channels.

Beacon stations may be used in connection with a variety of activities consistent with various aspects of the disclosed embodiments. In some embodiments, beacon stations may be used in connection with inventorying guest beacon devices. For example, in some embodiments, a beacon station may be located within and/or nearby a guest beacon device storage location. The beacon station may scan for guest beacon devices located in the guest beacon device storage location and may provide inventory information associated with the scanned beacons to a guest management system, allowing a user to determine how many and/or which guest beacon devices are located within the storage location.

In further embodiments, beacon stations may be used in connection with guest beacon device initialization and/or enrollment (e.g., communicating certain information to the guest beacon devices for storage by the guest beacon devices). For example, a beacon station associated with a guest management system may be configured to initialize guest beacon devices with guest information including, for example, and without limitation, guest names, guest photographs, guest contact information, guest medical information such as allergies, guest ability levels, guest payment and/or other account information (e.g., credit card number information), and/or the like. Guest beacon devices may be further initialized with link association information. For example, a beacon station may initialize a guest beacon device with information linking an associated guest to an assigned instructor (and/or a tracker device associated with the same), an assigned class, group, and/or session, and/or the like.

In certain embodiments, beacons stations may be used in connection with managing physical access rights. For example, a beacon station may be used to determine whether a guest associated with a guest beacon device and/or a tracker device should be allowed access to a ski lift, a backcountry gate, an attraction within an amusement park, and/or other facilitates offered to guests and/or guests participating in certain programs (e.g., exclusive lodge and/or snow sports school areas). A beacon station may scan proximate guest beacon devices and/or tracker devices and, based on information received from the guest beacon devices and/or tracker devices, determine whether associated guests and/or instructors have physical access rights to requested areas (which may involve checking for current access rights associated with the guests, instructors, and/or devices with the guest management service). Physical access control systems (e.g., gates, locks, and/or the like) may be actuated based on the results of the access control determination.

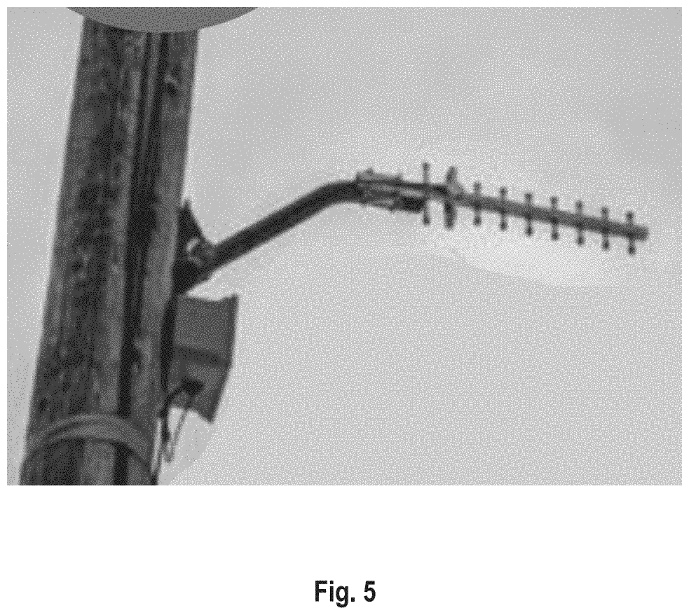

In yet further embodiments, beacon stations may be used in connection with payment systems that utilize guest beacon devices and/or tracker devices. For example, as described above, guest beacon devices and/or tracker devices may be initialized with certain payment information (e.g., credit card information and/or other account information). Beacon stations associated with payment locations such as, for example and without limitation, cash registers, may be used to scan associated guest beacon devices and/or tracker devices and/or effectuate transactions based, at least in part, on the account and/or payment information stored by the beacon devices. In certain embodiments, beacon stations may communicate with the guest management system in connection with managing transactions (e.g., checking available account balances and/or the like). An example of a beacon station or a tracker station is shown in FIG. 5.

Tracker Stations

Tracker stations may comprise fixed communication devices configured to communicate with tracker devices, beacon stations, and/or other tracker stations. One or more tracker stations may be distributed throughout a venue and may operate as network gateways establishing an open-area wireless communication network within the venue that may, in some instances, be private and/or otherwise dedicated. Consistent with embodiments disclosed herein, the communication network may use a LPWAN communication technology such as, for example and without limitation, LoRa (e.g., using sub-gigahertz RF bands like 915 MHz). While many tracker stations may be fixed in location, certain tracker stations may be mobile and/or otherwise allow for relocation within a venue to facilitate optimizing locations of tracker stations within the venue and improve network coverage.

In some embodiments, tracker stations may act as a gateway between the LPWAN established by the tracker stations to a public wide area network such as, for example, the internet and/or a local area network. In this manner, the tracker stations may enable devices connected to its network (e.g., tracker devices and/or beacon stations) to communicate with the guest management system. Although illustrated as separate devices, it will be appreciated that in some embodiments, certain tracker stations may include and/or otherwise incorporate elements and/or the functionality of beacon stations.

In certain embodiments, tracker devices, beacon stations, and/or tracker stations employing LoRa may implement communication multiplexing using GPS pulse per second (“PPS”) to send data at a specific time within a polling of a particular tracker device and/or a beacon station and/or associated identification numbers. For example, each tracker device may be associated with a tracker device ID, and each tracker device ID may be associated with a specific time slot to transmit data to connected tracker stations so that multiple tracker devices do not transmit information simultaneously. Tracker devices may receive relatively precise time information using PPS from a GPS and/or any other suitable time synchronization method. In certain embodiments, tracker stations may be configured to listen (and not necessarily transmit) on a LoRa-based communications network for tracker devices and/or beacon stations to transmit during assigned time slots, which may help to facilitate compliance with relevant regulatory requirements.

In some configurations, tracker stations may listen for communications from tracker devices and/or beacon stations. For example, for each minute, one second may be divided into four transmission slots, so that during second 0 to 1, tracker devices 1-4 transmit during their respective 250 milliseconds, tracker device 5 transmits at second 1 and 0 milliseconds, and tracker 6 at 1 second and 250 milliseconds. Under this transmission paradigm, the number of tracker devices and/or beacon stations for the given frequency may be 240 (4×60). LoRa may enable a multitude of parameter combinations including various usable frequencies, spreading factors, and/or signal bandwidths. For example, one group of tracker devices and/or beacon stations may use 915 MHz, another group can use 916 MHz, and/or the like, enabling for the disclosed architecture to be readily scaled as needed. An example of a tracker station is shown in FIG. 5.

Guest Management System

A guest management system may be configured to communicate to and/or receive information from various devices and/or systems within the illustrated architecture. For example, the guest management system may be configured to initialize guest beacon devices and/or tracker devices with information including, for example and without limitation, guest information, instructor information, and/or link association information consistent with embodiments disclosed herein. The guest management system may further receive information from tracker devices and/or beacon stations, in some instances by way of the area network established by the tracker stations.

In some embodiments, the guest management system may be local to a venue. In other embodiments, the guest management system may comprise a cloud-based hosted system and/or service.

In some embodiments, the guest management system may maintain a database of guest information, instructor information, and/or link association information, and/or update the database as new information is received. The guest management system may generate responses to requests (e.g., inquiries received from beacon stations and/or tracker devices) relating to information included in the database. The guest management system may further perform certain messaging services, allowing for communication between instructor tracker devices and/or the guest management system.

It will be appreciated that a number of variations can be made to the architecture, relationships, and examples presented in connection with FIG. 1 within the scope of the inventive body of work. For example, certain device and/or system functionalities may be performed by a single device and/or system and/or by any suitable combination of devices and/or systems. Thus, it will be appreciated that the architecture, relationships, and examples presented in connection with FIG. 1 are provided for purposes of illustration and explanation, and not limitation.

Embodiments of the disclosed systems and methods and/or the architecture illustrated in FIG. 1 may be used in a variety of contexts and/or applications to facilitate a number of functionalities and/or operations including, for example and without limitation, the following examples:

### Example—Guest Beacon Device Enrollment Initialization

A guest may enroll in a snow sports school class at a winter sports resort. In connection with their enrollment, they may be issued a guest beacon device. The guest beacon device may be initialized with certain guest information using a tracker device and/or a beacon station (e.g., a beacon station associated with the guest management system and/or the like). The guest information may include, for example, and without limitation, the guest's name, a photograph of the guest, medical information associated with the guest, an ability level of the guest, certain guest preferences and/or goals of the guest in connection with the class, emergency contact information, and/or the like. The guest information may further include information relating to access rights and/or payment information (e.g., credit card and/or other account information) associated with the guest.

The guest beacon device may further be initialized with link association information linking the guest to an assigned instructor. The link association information may comprise, for example and without limitation, information associated with an instructor's name, an associated instructor's assigned tracker device (e.g., tracker device ID number information, an assigned class and/or session, and/or the like).

In some embodiments, the link association information may be generated and/or otherwise entered using the guest management system, which may be configured to provision the guest beacon device with the link association information via a beacon station. In further embodiments, the link association information may be automatically generated as part of an initialization and/or enrollment process using a tracker device associated with an instructor. For example, a tracker device may be set to a linking mode by an instructor and/or otherwise initialized to perform a linking operation through a suitable gesture-based control (e.g., double tapping a guest's beacon device against the tracker device and/or the like). The tracker device may, in response to the control command, provision the link association information to the guest beacon device. For example, the tracker device may transmit one or more of a tracker device ID, an associated instructor's name, an associated class and/or session, and/or the like, to the guest beacon device for storage. In this manner, an associative link between the instructor and the guest (via their respective devices) may be established. In some embodiments, link information established by a tracker device may be communicated to the guest management system via the wide area network.

### Example—Beacon Device Enrollment Update

During the course of the snow sports class, the guest's skills may progress faster than other students and, therefore, the guest may benefit from more advanced instruction. Accordingly, the guest's assigned instructor at the start of the day may determine that it would be beneficial for the guest to change classes and/or instructors. While on the mountain, the original instructor may meet with an instructor teaching a more advanced class. The new instructor may enroll the guest in the more advanced class by generating an association link between the new instructor's tracker device and the guest's guest beacon device.

For example, the new instructor's tracker device may be set to a linking mode and/or otherwise initialized to perform a linking operation through some sort of gesture-based control (e.g., double tapping the guest's beacon device against the tracker device and/or the like). The new instructor's tracker device may provision the link association information to the guest beacon device. For example, the tracker device may transmit one or more of a tracker device ID, the new instructor's name, the new class and/or session, etc., to the guest beacon device for storage. In this manner, an associative link between the new instructor and the guest (via their respective devices) may be established. In some embodiments, link information established by the new instructor's tracker device may be communicated to the guest management system via the wide area network. In this manner, the snow sports school may have records indicating that the guest has switched classes and is now under the responsibility of the new instructor.

### Example—Access and Payment Authentication Using Guest Beacon Devices

The guest's beacon device may be used in connection with physical access management at the winter resort. For example, in some embodiments, the guest's beacon device may be initialized with access information, akin to an electronic lift ticket, allowing the guest access to ski lifts at the winter resort. A beacon station associated with a physical access control system (e.g., a gate) at the base of the ski lift may scan proximate guest beacon devices (and/or tracker devices) and determine whether the guests and/or instructors are permitted access to the lifts. In some embodiments, this may involve communicating with the guest management system.

After several hours recreating on the mountain, the guest may become hungry and wish to visit a lodge and purchase food. As discussed above, the guest's beacon device may be initialized with certain payment and/or account information provided by the guest. Beacon stations associated with payment locations at the lodge may be used to scan the guest's beacon device (and/or tracker device) and to effectuate a transaction based, at least in part, on the account and/or payment information stored by the guest beacon device. In certain embodiments, beacon stations may communicate with the guest management system in connection with authorizing and/or managing such transactions (e.g., checking available account balances and/or the like).

### Example—Identification of Separated Guests

During the course of the snow sports class, the guest may inadvertently become separated from the rest of the class and/or their instructor. The instructor's tracking device may alert the instructor after determining that the guest's guest beacon device is no longer within scanning range of the instructor's tracking device. The instructor's tracking device may further alert the guest management system and/or other instructor tracking devices that the guest has become separated from their instructor.

In other circumstances, a beacon station may scan and identify a nearby guest beacon device that is associated with an instructor by a link association (e.g., a link association recorded by the guest management system and/or the guest beacon device). The beacon station and/or the guest management system may also determine, however, that the tracker device associated with the guest's instructor is not within range of the beacon station, indicating that the guest may have become separated from their instructor. The beacon station may alert the guest management system of the circumstances and the beacon station and/or the guest management system may alert other instructor tracking devices that the guest has become separated from their instructor and provide them with the guest's location (i.e., the location of the beacon station).

For example, referring back to FIG. 1, a group of guest beacon devices—beacon device group 4—may be detected by a beacon station—beacon station 2. The guest management system may determine that the guests associated with beacon device group 4 have become separated from their instructor by either determining that the locations of known tracker devices (and associated instructors) are not near the location of beacon station 2 and/or by determining that beacon station 2 does not also detect a proximate tracker device. The guest management system in response may alert the tracker device associated with the guests' assigned instructor and/or the tracker devices of other nearby instructors, who may assist in reuniting the group of guests with their assigned instructor.

In further circumstances, a tracker device associated with an instructor not assigned to a separated guest may scan and identify the guest beacon device associated with the separated guest and communicate a location of the separated guest to the guest management system. The guest management system may inform the tracker device associated with instructor that scanned the guest beacon device of the separated guest that they are in proximity to a separated guest. In other embodiments, when an assigned instructor determines that they have inadvertently become separated from a guest, the instructor may use their tracker device to inform tracker devices associated with other instructors (via peer-to-peer communication channels and/or the venue wireless communication network) and/or the guest management system of the separated guest, and request that other tracker devices and/or beacon stations within the venue listen and/or otherwise look for the guest beacon device of the separated guest and alert the guest management system (and/or the assigned instructor's tracker device) when it has been scanned.

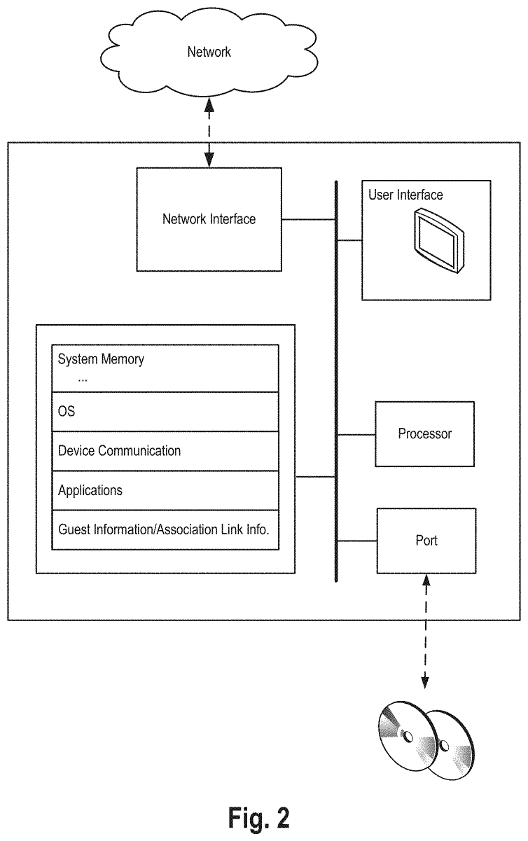

FIG. 2 illustrates an example of a system that may be used to implement certain embodiments of the systems and methods of the present disclosure. Certain elements associated with the illustrated system (but in some cases not necessarily all elements) may be included in a guest beacon system, a tracker device, a tracker station, a beacon station, a guest management system, and/or any other device, system, and/or service configured to implement the embodiments of the systems and methods disclosed herein and/or various aspects thereof.

As illustrated in FIG. 2, the system may include: a processing unit; system memory, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit; a port for interfacing with removable memory that may include one or more diskettes, optical storage mediums, and/or other non-transitory computer-readable storage mediums (e.g., flash memory, thumb drives, USB dongles, compact discs, DVDs, etc.); a network interface for communicating with other systems via one or more network connections using one or more communication technologies; a user interface that may include a display and/or one or more input/output devices such as, for example, a touchscreen, a keyboard, a mouse, a track pad, and the like; and one or more busses for communicatively coupling the elements of the system.

The operation of the system may be generally controlled by the processing unit by executing software instructions and programs stored in the system memory and/or internal memory of the processing unit. The system memory may store a variety of executable programs or modules for controlling the operation of the system. For example, the system memory may include an operating system (“OS”) that may manage and coordinate, at least in part, system hardware resources and provide for common services for execution of various applications, modules, and/or services.

The system memory may further include, without limitation, communication software configured to enable in part communication with and by the system; one or more applications; guest information, instructor information, and/or association link information; and/or any other information, executable modules, and/or applications configured to implement embodiments of the systems and methods disclosed herein.

Athlete Performance Tracking

A variety of other uses and features may be employed as part of a guest management and tracking system of the present disclosure. For example, the system may be useful for contact tracing, such as for tracing which guests an guest symptomatic or diagnosed with an infections disease may have had contact with. Contact tracing, such as for airborne illnesses, may be vital to safety within a venue. In other examples, the system of the present disclosure may alert a venue to the location of individual guests who may be caught in an avalanche, allowing for swift extraction.

According to aspects of the present disclosure, a venue may track performance characteristics of guests, or allow access to certain locations for guests. For example, the devices and systems of the present disclosure may be used to limit which guests may enter a certain building or may board a certain attraction or transportation vehicle. The system may further be used to track vital information for guests needing assistance, such as if a guest has fallen and become injured.

Athlete Performance Tracking

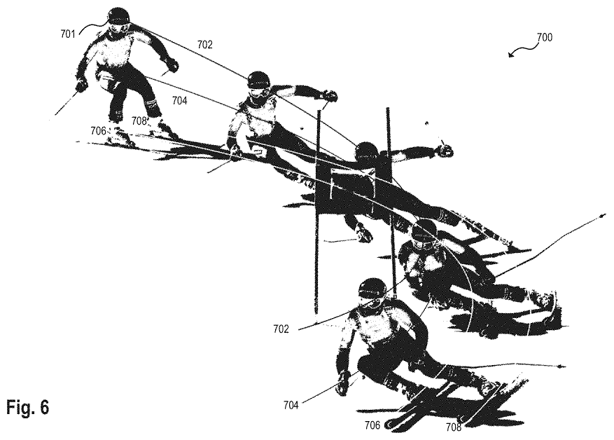

Similar to the systems described above, an athlete location and performance system of the present technology may include a system configured and adapted to track and communicate athlete performance data to a central system. For example, an athlete beacon device may be used in a system similar to system 10 described with reference to FIG. 1 in place of a guest beacon device 102, 104 etc. Moreover, the athlete location and performance tracking system may include additional sensors to track characteristics of athlete performance. In some examples, those sensors may track the relative position of parts of the body. FIG. 6 shows an example of an athlete 701 as part of an athlete performance system 700. The location of the athlete's head or nose 702, center of gravity or body 704, right ski or boot 706 and left ski or boot 708 may be tracked as the athlete performs a function, such as a gate turn. Athlete 701 of FIG. 6 is just one example of athlete performance that can be tracked, as the system 700 may be applied to any other application contemplated herein, including mountain biking.

In some embodiments, the sensor may track the position of the sensor relative to another sensor, or relative to the athlete beacon device. In other examples, the sensor may include any number of other sensors, including an altimeter, barometer, gyroscope, accelerometer, proximity sensor, ambient light sensor, or any other sensor that may measure usable information. From the data gathered from the sensor, the system may be configured and adapted to provide an alert. For example, if the athlete performance data shows unusual acceleration and deceleration of a guest, the system may detect a fall or other unusual incident requiring assistance. In other instances, the system may be used to track when guests, such as students in an instructional class, leave a certain boundary or halo, alerting the instructor that the guest requires assistance while also providing the precise location of the guest.

According to aspects of the present technology, the guest sensor may include a guest smart phone device and guest wearable devices. For example, a smart watch may include sensors that may communicate with the guest beacon device and/or the tracker device to provide the information discussed herein.

Scheduling

The guest tracking and management system and method of the present disclosure may further include scheduling management for guests as well as for venue representatives. For example, in some embodiments of the present disclosure, guests may be assigned to a certain class with a certain instructor or venue representative, and the guest management system may alert the guest of the assignment, including timing and location of the class. In other embodiments, the system may provide venue representatives with a schedule of their assignments, including for example the location and timing of each class the representative is to teach.

In some aspects of the present technology, the system may be programmed to automatically schedule which venue representatives corresponded with which groups of guests and classes for guests. The system may alert the venue representatives of their assignments, and may further provide notifications to the venue if the representative is not present when and where assigned. In some aspects, the system may further track the time when the venue representative is “on duty” or working, as opposed to “off duty.” For example, a ski school instructor may spend the majority of the day on the mountain, including “on duty” and “off duty” time. The system may be configured and adapted to track the representative's work time and provide for payroll functions to compensate the representative for time worked.

The systems and methods disclosed herein are not limited to any specific computer, device, service, or other apparatus architecture and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network. Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, an optical storage medium, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present aspects are to be considered as illustrative and not restrictive, and the invention is not to be limited to the details given herein, but may be modified within the scope and equivalents of the disclosed aspects.

What is claimed is:

1. A guest tracking and management system, comprising:
at least one guest beacon device being associated with a guest within a venue;
at least one tracker device being associated with a venue representative;
at least one beacon station being associated with a location within the venue;
at least one tracker station being associated with a location within the venue; and
a centralized guest management system;
wherein the guest beacon device communicates with the tracker device and the beacon station using a short-range communication protocol, the tracker device and the beacon station communicate with the tracker station using a short-range communication protocol, and the beacon station and tracker station communicate with the centralized guest management system using a low-power wide-area network.

2. The system of claim 1, wherein the short range communication protocol is Bluetooth Low Energy.

3. The system of claim 1, wherein the short range communication protocol is ultra-wideband.

4. The system of claim 1, wherein the short range communication protocol is RFID.

5. The system of claim 1, wherein the low-power wide-area network is LoRa.

6. The system of claim 1, wherein the LoRa technology utilizes RF bands below 1 gigahertz.

7. The system of claim 1, further comprising a first plurality of guest beacon devices and a second plurality of guest beacon devices, wherein each of the first plurality of guest beacon devices is assigned to a guest in a first group and each of the second plurality of guest beacon devices is assigned to a guest in a second group.

8. The system of claim 7, further comprising a first tracker device assigned to a first venue representative and a second tracker device assigned to a second venue representative.

9. The system of claim 8, where in the first plurality of guest beacon devices are assigned to the first tracker device in the centralized guest management system.

10. The system of claim 9, wherein the second plurality of guest beacon devices are assigned to the second tracker device in the centralized guest management system.

11. The system of claim 10, wherein one of the first plurality of guest beacon devices is reassigned to the second tracker device in the guest management system.

12. The system of claim 1, wherein the tracker device communicates the location of the venue representative and contacts with guests to the tracker station, and wherein the tracker station communicates the location of the venue representative and contacts with guests to the centralized guest management system.

13. The system of claim 1, wherein the beacon device communicates the location of the guests to the centralized guest management system.

14. An athlete location and performance tracking system, comprising:
at least one athlete beacon device being associated with an athlete within a venue;
at least one athlete sensor associated with and communicating data to the athlete beacon device.
at least one beacon station being associated with a location within the venue; and
a centralized guest management system;
wherein the athlete beacon device communicates with the beacon station using a short-range communication protocol and the beacon station communicate with the centralized athlete management system using a low-power wide-area network.

15. The system of claim 12, wherein the athlete sensor is one of an altimeter,

16. The system of claim 12, wherein the athlete sensor is configured and adapted to measure the location of the sensor relative to the athlete beacon device.

17. The system of claim 12, where in the data from the athlete sensor and athlete beacon device is communicated to the centralized athlete management system through the at least one beacon station.

18. A method for tracking and managing guests within a venue, comprising:
assigning a beacon device to each guest;
assigning a tracker device to each venue representative;
providing at least one tracker station for communicating the information from a tracker device to a centralized guest management system;
providing at least one beacon station for communicating information from a beacon device to the centralized guest management system;
wherein the location of each beacon device and each tracker device is communicated to a centralized guest management system by the tracker station and beacon station.

19. The method of claim 18, wherein tracker device communicates with the tracker station and the beacon device communicates with the beacon station using a short range communication protocol including at least one of Bluetooth Low Energy, ultra-wideband and RFID.

20. The method of claim 18, wherein the beacon station and tracker station communicate with the centralized guest management system using a LoRa low-power wide-area network.
